(19) United States
(12) Patent Application Publication
(10) Pub. No.: US 2013/0324489 A1
(43) Pub. Date: Dec. 5, 2013

(54) NEW ANTIFUNGAL COMPOSITIONS

(71) Applicants: Jacobus Stark, Echt (NL); Angelique De Rijk, Echt (NL)

(72) Inventors: Jacobus Stark, Echt (NL); Angelique De Rijk, Echt (NL)

(73) Assignee: DSM IP ASSETS B.V., Heerlen (NL)

(21) Appl. No.: 13/985,486

(22) PCT Filed: Mar. 1, 2012
(86) PCT No.: PCT/EP2012/053513

§ 371 Date: Aug. 14, 2013

(30) Foreign Application Priority Data
Mar. 3, 2011 (EP) 11156775.6

(51) Int. Cl. A01N 43/90; A23L 3/3463; A01N 43/76; A01N 47/38; A01N 43/38

(52) U.S. Cl. CPC A01N 43/90; A01N 47/38; A01N 43/38; A01N 43/76; A23L 3/34635
USPC 514/31; 426/532

(57) ABSTRACT

The present invention relates to new antifungal compositions and their use in the treatment of agricultural products.

### FIELD OF THE INVENTION

The present invention discloses new antimicrobial compositions to control plant diseases and to prevent microbial spoilage of crops.

### BACKGROUND OF THE INVENTION

It is estimated that about 25% of the world crop production is lost due to microbial spoilage, of which spoilage by fungi is by far the most important cause. Not only from an economical point of view, but also from a humane point of view it is of great importance to prevent spoilage of food products. After all, in many parts of the world people suffer from hunger.

Success in combating plant and crop diseases and in reducing the damage they cause to yields and quality depends greatly on the timely application of fungicides. The prolonged and frequent use of many fungicides such as e.g. benzamidazoles has contributed to reduce their effectiveness thanks to the development of phenomena of resistance.

An important group of fungicides are the dicarboximides. The mode of action of dicarboximides has not been fully characterized, but they affect fungal osmotic regulation, as well as resulting in some other non-specific toxic effects. Dicarboximides are protectant fungicides with low phytotoxicity and short withholding periods. Because of the short withholding period, they have been widely used close to harvest.

Dicarboximides were introduced in the mid-1970s, principally for the control of Botrytis cinerea in grapes. They were used as an alternative to the benzimidazole fungicides, to which resistance had developed in B. cinerea. In WO 2007/104677 a method for inducing tolerance against bacterioses of plants is disclosed wherein the plants are treated with inter alia a strobilurin and famoxadone. EP 2 036 438 A1 discloses the use of iprodione to protect harvested fruit or vegetables against phytopathogenic fungi. GB 2 213 727 A discloses synergistic fungicidal and acaricidal compositions containing two or three active ingredients. Iprodione is disclosed as one of the ingredients.

Dicarboximide-resistant isolates were rarely observed in nature in the years immediately after the introduction of dicarboximide fungicides in the mid-1970s. However, by the early 1980s, resistant isolates were common on several crops (see e.g. Locke et al., 1988; Pommer et al., 1982; Yourman et al., 1999).

For many decades, the polyene macrolide antimycotic natamycin has been used to prevent fungal growth on food products such as cheeses and sausages. This natural preservative, which is produced by fermentation using Streptomyces natalensis, is widely used throughout the world as a food preservative and has a long history of safe use in the food industry. In U.S. Pat. No. 5,597,598 the use of an antifungal composition comprising a polyene antifungal compound, an acidic antifungal compound and an additional organic acid or its alkali or earth alkali salt to treat food and agricultural products is disclosed. Natamycin is very effective against all known food spoilage fungi. Although natamycin has been applied in e.g. the cheese industry for many years, up to now development of resistant fungal species has never been observed.

Consequently, it can be concluded that there is a severe need for more effective antimicrobial compositions, e.g. antifungal compositions, for the treatment of fungal growth in and on plants and crops.

### DESCRIPTION OF THE INVENTION

The present invention solves the problem by providing a new synergistic antimicrobial, e.g. antifungal, composition comprising a polyene antifungal compound and at least one antifungal compound from the family of dicarboximide fungicides. As used herein, the term “synergistic” means that the combined effect of the antifungal compounds when used in combination is greater than their additive effects when used individually.

In general, synergistic activity of two active ingredients can be tested in for example the analysis of variance model using the treatment interaction stratum (see Slinker, 1998). Relative efficacy can be calculated by means of the following formula: ((value of evolution status of untreated control−value of evolution status of composition)/(value of evolution status of untreated control))*100. An interaction coefficient can then be calculated by means of the following formula: ((relative efficacy of combination compound A+compound B)/(relative efficacy of compound A+relative efficacy of compound B))*100. An interaction coefficient larger than 100 indicates synergy between the compounds.

Alternatively, synergy can be calculated as follows: the antifungal activity (in %) of the individual active ingredients can be determined by calculating the reduction in mould growth observed on products treated with the active ingredients in comparison to the mould growth on products treated with a control composition. The expected antifungal activity (E in %) of the combined antifungal composition comprising both active ingredients can be calculated according to the Colby equation (Colby, 1967): E=X+Y−[(X·Y)/100], wherein X and Y are the observed antifungal activities (in %) of the individual active ingredients X and Y, respectively. If the observed antifungal activity (O in %) of the combination exceeds the expected antifungal activity (E in %) of the combination and the synergy factor O/E is thus >1.0, the combined application of the active ingredients leads to a synergistic antifungal effect.

In an embodiment of the invention, the at least one antifungal compound from the family of dicarboximide fungicides is selected from the group consisting of famoxadone, fluoroimide, chlozolinate, dichlozoline, iprodione, isovaledione, myclozolin, procymidone and vinclozolin. In a preferred embodiment the at least one antifungal compound from the family of dicarboximide fungicides is selected from the group consisting of iprodione, procymidone and vinclozolin. In an embodiment the compositions may also contain two or more different antifungal compounds from the family of dicarboximide fungicides. It is to be understood that derivatives of antifungal compounds from the family of dicarboximide fungicides including, but not limited to, salts or solvates of antifungal compounds from the family of dicarboximide fungicides or modified forms of antifungal compounds from the family of dicarboximide fungicides may also be applied in the compositions of the invention. Examples of commercial products containing dicarboximide fungicides such as vinclozolin are the products with the brand name Curalan® (vinclozolin) or Ronilan® (vinclozolin). Examples of commercial products containing dicarboximide fungicides such as iprodione are the products with the brand name Rovral® (iprodione) or Chipco 26019® (iprodione). Said commercial products can be incorporated in the present invention.

In an embodiment the polyene antifungal compound is selected from the group consisting of natamycin, nystatin, amphotericin B, trienin, etruscomycin, filipin, chainin, dermostatin, lymphosarcin, candicidin, aureofungin A, aureofungin B, hamycin A, hamycin B and lucensomycin. In a preferred embodiment the polyene antifungal compound is natamycin. In an embodiment the compositions may also contain two or more different polyene antifungal compounds. It is to be understood that derivatives of polyene antifungal compounds including, but not limited to, salts or solvates of polyene antifungal compounds or modified forms of polyene antifungal compounds may also be applied in the compositions of the invention. Examples of commercial products containing natamycin are the products with the brand name Delvocid®. Such products are produced by DSM Food Specialties (The Netherlands) and may be solids containing e.g. 50% (w/w) natamycin or liquids comprising between e.g. 2-50% (w/v) natamycin. Said commercial products can be incorporated in the compositions of the invention.

The composition of the present invention generally comprises from about 0.005 g/l to about 100 g/l and preferably from about 0.01 g/l to about 50 g/l of a polyene antifungal compound. Preferably, the amount is from 0.01 g/l to 3 g/l.

The composition of the present invention generally comprises from about 0.0001 g/l to about 2000 g/l and preferably from about 0.0005 g/l to about 1500 g/l of an antifungal compound from the family of dicarboximide fungicides. More preferably, the amount is from 0.001 g/l to 1000 g/l.

In an embodiment the composition of the present invention further comprises at least one additional compound selected from the group consisting of a sticking agent, a carrier, a colouring agent, a protective colloid, an adhesive, a herbicide, a fertilizer, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber and an antioxidant. A further antimicrobial antifungal compound may be an antifungal compound (e.g. imazalil, thiabendazole or chlorthalonil) or a compound to combat insects, nematodes, mites and/or bacteria. Of course, the compositions according to the invention may also comprise two or more of any of the above additional compounds. Any of the above mentioned additional compounds may also be combined with the polyene antifungal compound and/or the at least one antifungal compound from the family of dicarboximide fungicides in case the antifungal compounds are applied separately. In an embodiment the additional compounds are additives acceptable for the specific use, e.g. food, feed or agriculture. Additional compounds suitable for use in food, feed or agriculture are known to the person skilled in the art.

In a specific embodiment the further antimicrobial compound is a natural crop protection compound belonging to the group of phosphites, e.g. KH₂PO₃ or K₂HPO₃ or a mixture of both phosphite salts. Phosphite containing compounds as used herein means compounds comprising a phosphite group, i.e. PO₃ (in the form of e.g. H₂PO₃⁻, HPO₃²⁻ or PO₃³⁻) or any compound which allows the release of a phosphite ion including compounds such as phosphorous acid and phosphonic acid as well as derivatives thereof such as esters and/or alkali metal or alkaline earth metal salts thereof. In case the compositions of the present invention comprise a polyene antifungal compound (e.g. natamycin) and at least one phosphite containing compound, they preferably comprise 0.1 g or less lignosulphonate, more preferably 0.1 g or less polyphenol, per gram polyene antifungal compound. Preferably, they comprise 0.01 g or less lignosulphonate, more preferably 0.01 g or less polyphenol, per gram polyene antifungal compound. In particular, they are free of lignosulphonate and preferably free of polyphenol. Suitable examples of phosphite containing compounds are phosphorous acid and its (alkali metal or alkaline earth metal) salts such as potassium phosphites e.g. KH₂PO₃ and K₂HPO₃, sodium phosphites and ammonium phosphites, and (C₁-C₄) alkyl esters of phosphorous acid and their salts such as aluminum ethyl phosphite (fosetyl-Al), calcium ethyl phosphite, magnesium isopropyl phosphite, magnesium isobutyl phosphite, magnesium sec-butyl phosphite and aluminum N-butyl phosphite. Of course, mixtures of phosphite containing compounds are also encompassed. A mixture of e.g. KH₂PO₃ and K₂HPO₃ can easily be obtained by e.g. adding KOH or K₂CO₃ to a final pH of 5.0-6.0 to a KH₂PO₃ solution. As indicated above, precursor-type compounds which in the crop or plant are metabolized into phosphite compounds can also be included in the compositions of the present invention. Examples are phosphonates such as the fosetyl-aluminium complex. In e.g. a crop or plant the ethyl phosphonate part of this molecule is metabolized into a phosphite. An example of such a compound in the commercial ethyl hydrogen phosphonate product called Aliette® (Bayer, Germany). The ratio of phosphite to natamycin (in weight) in the compositions is in general between 2:1 to 500:1 (w/w), preferably between 3:1 to 300:1 (w/w) and more preferably between 5:1 to 200:1 (w/w).

Compositions according to the invention may have a pH of from 1 to 10, preferably of from 2 to 9, more preferably of from 3 to 8 and most preferably of from 4 to 7. They may be solid, e.g. powder compositions, or may be liquid. The compositions of the present invention can be aqueous or non-aqueous ready-to-use compositions, but may also be aqueous or non-aqueous concentrated compositions/suspensions or stock compositions, suspensions and/or solutions which before use have to be diluted with a suitable diluent such as water or a buffer system. Alternatively, the compositions of the invention can also be used to prepare coating emulsions. The compositions of the present invention can also have the form of concentrated dry products such as e.g. powders, granulates and tablets. They can be used to prepare compositions for immersion or spraying of products such as agricultural products including plants, crops, vegetables and/or fruits. Of course, the above is also applicable when the polyene antifungal compound and the at least one antifungal compound from the family of dicarboximide fungicides are applied as separate compositions.

In a further aspect the invention relates to a kit comprising a polyene antifungal compound and at least one antifungal compound from the family of dicarboximide fungicides. The polyene antifungal compound and the at least one antifungal compound from the family of dicarboximide fungicides may be present in two separate packages, e.g. containers. The components of the kit may be either in dry form or liquid form in the package. If necessary, the kit may comprise instructions for dissolving the compounds. In addition, the kit may contain instructions for applying the compounds.

In a further aspect the invention pertains to a method for protecting a product against fungi by treating the agricultural product with a polyene antifungal compound and at least one antifungal compound from the family of dicarboximide fungicides. In addition, the product can be treated with other antifungal and/or antimicrobial compounds either prior to, concomitant with or after treatment of the products with the polyene antifungal compound and the at least one antifungal compound from the family of dicarboximide fungicides. The product may be treated by sequential application of the polyene antifungal compound and the at least one antifungal compound from the family of dicarboximide fungicides or vice versa. Alternatively, the product may be treated by simultaneous application of the polyene antifungal compound and the at least one antifungal compound from the family of dicarboximide fungicides. In case of simultaneous application, the compounds can be present in different compositions that are applied simultaneously or the compounds may be present in a single composition. In yet another embodiment the product may be treated by separate or alternate modes of applying the antifungal compounds. In an embodiment the invention is directed to a process for the treatment of products by applying the polyene antifungal compound and the at least one antifungal compound from the family of dicarboximide fungicides to the products. By applying the compounds fungal growth on or in the products can be prevented. In other words, the compounds protect the products from fungal growth and/or from fungal infection and/or from fungal spoilage. The compounds can also be used to treat products that have been infected with a fungus. By applying the compounds the disease development due to fungi on or in these products can be slowed down, stopped or the products may even be cured from the disease. In an embodiment of the invention the products are treated with a composition or kit according to the invention. In an embodiment the product is a food, feed, pharmaceutical, cosmetic or agricultural product. In a preferred embodiment the product is an agricultural product.

The polyene antifungal compound and the at least one antifungal compound from the family of dicarboximide fungicides, the compositions according to the invention and the kits according to the invention can be applied to the products by spraying. Other methods suitable for applying these compounds, compositions and kits in liquid form to the products are also a part of the present invention. These include, but are not limited to, dipping, watering, drenching, introduction into a dump tank, vaporizing, atomizing, fogging, fumigating, painting, brushing, dusting, foaming, spreading-on, packaging and coating (e.g. by means of wax or electrostatically). In addition, the antifungal compounds may also be injected into the soil. Spraying applications using automatic systems are known to reduce the labour costs and are cost-effective. Methods and equipment well-known to a person skilled in the art can be used for that purpose. The compositions according to the invention can be regularly sprayed, when the risk of infection is high. When the risk of infection is lower spray intervals may be longer. Depending on the type of application, the amount of polyene antifungal compound applied may vary from 5 ppm to 10,000 ppm, preferably from 10 ppm to 5,000 ppm and most preferably from 20 to 1,000 ppm. Depending on the type of application, the amount of the at least one antifungal compound from the family of dicarboximide fungicides applied may vary from 10 ppm to 5,000 ppm, preferably from 20 ppm to 3,000 ppm and most preferably from 50 to 1,000 ppm.

In a specific embodiment the agricultural product can be treated post-harvest. By using a polyene antifungal compound and the at least one antifungal compound from the family of dicarboximide fungicides the control of post-harvest and/or storage diseases is achieved for a long period of time to allow transport of the harvested agricultural product over long distances and under various storage conditions with different controlled atmosphere systems in respect of temperature and humidity. Post-harvest storage disorders are e.g. lenticel spots, scorch, senescent breakdown, bitter pit, scald, water core, browning, vascular breakdown, CO₂ injury, CO₂ or O₂ deficiency, and softening. Fungal diseases may be caused for example by the following fungi: Mycosphaerella spp., Mycosphaerella musae, Mycosphaerella fragariae, Mycosphaerella citri; Mucor spp., e.g. Mucor piriformis; Monilinia spp., e.g. Monilinia fructigena, Monilinia laxa; Phomopsis spp., Phomopsis natalensis; Colletotrichum spp., e.g. Colletotrichum musae, Colletotrichum gloeosporioides, Colletotrichum coccodes; Verticillium spp., e.g. Verticillium theobromae; Nigrospora spp.; Botrytis spp., e.g. Botrytis cinerea; Diplodia spp., e.g. Diplodia citri; Pezicula spp.; Alternaria spp., e.g. Alternaria citri, Alternaria alternata; Septoria spp., e.g. Septoria depressa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Fusarium spp., e.g. Fusarium semitectum, Fusarium moniliforme, Fusarium solani, Fusarium oxysporum; Cladosporium spp., e.g. Cladosporium fulvum, Cladosporium cladosporioides, Cladosporium cucumerinum, Cladosporium musae; Penicillium spp., e.g. Penicillium funiculosum, Penicillium expansum, Penicillium digitatum, Penicillium italicum; Phytophthora spp., e.g. Phytophthora citrophthora, Phytophthora fragariae, Phytophthora cactorum, Phytophthora parasitica; Phacydiopycnis spp., e.g. Phacydiopycnis malirum; Gloeosporium spp., e.g. Gloeosporium album, Gloeosporium perennans, Gloeosporium fructigenum, Gloeosporium singulata; Geotrichum spp., e.g. Geotrichum candidum; Phlyctaena spp., e.g. Phlyctaena vagabunda; Cylindrocarpon spp., e.g. Cylindrocarpon mali; Stemphyllium spp., e.g. Stemphyllium vesicarium; Thielaviopsis spp., e.g. Thielaviopsis paradoxy; Aspergillus spp., e.g. Aspergillus niger, Aspergillus carbonarius; Nectria spp., e.g. Nectria gaffigena; Cercospora spp., e.g. Cercospora angreci, Cercospora apii, Cercospora atrofiliformis, Cercospora musae, Cercospora zeae-maydis. maydis.

Another aspect of the present invention relates to the use of a polyene antifungal compound and at least one antifungal compound from the family of dicarboximide fungicides to protect a product against fungi. As indicated above, the compounds may be used, e.g. applied, sequentially or simultaneously. In an embodiment the invention relates to a use, wherein a composition or kit according to the invention is applied to the product. In an embodiment the product is a food, feed, pharmaceutical, cosmetic or agricultural product. In a preferred embodiment the product is an agricultural product.

In a specific embodiment the polyene antifungal compound and at least one antifungal compound from the family of dicarboximide fungicides can be used in medicine, e.g. to treat and/or prevent fungal diseases. The polyene antifungal compound and at least one antifungal compound from the family of dicarboximide fungicides can for instance be used in the form of a pharmaceutical composition. The composition may further comprise pharmaceutically acceptable excipients. The antifungal compounds may be administered orally or parenterally. The type of composition is dependent on the route of administration.

A further aspect of the invention is directed to a product treated with a polyene antifungal compound and at least one antifungal compound from the family of dicarboximide fungicides. In an embodiment the product is treated with a composition or kit according to the invention. The invention is therefore directed to a product comprising a polyene antifungal compound and at least one antifungal compound from the family of anilinopyrimidines. The treated products may comprise a polyene antifungal compound and at least one antifungal compound from the family of dicarboximide fungicides on their surface and/or inside the product. Alternatively, the treated products may comprise a coating comprising these compounds. In an embodiment the treated products comprise from 0.000001 to 200 mg/dm², preferably 0.00001 to 100 mg/dm², more preferably from 0.00005 to 10 mg/dm² of the polyene antifungal compound on their surface. In a further embodiment they comprise from 0.000001 to 200 mg/dm², preferably 0.00001 to 100 mg/dm², more preferably from 0.00005 to 10 mg/dm² of the at least one antifungal compound from the family of dicarboximide fungicides on their surface. In an embodiment the product is a food, feed, pharmaceutical, cosmetic or agricultural product. In a preferred embodiment the product is an agricultural product.

The term “food products” as used herein is to be understood in a very broad sense and includes, but is not limited to, cheese, cream cheese, shredded cheese, cottage cheese processed cheese, sour cream, dried fermented meat product including salamis and other sausages, wine, beer, yoghurt, juice and other beverages, salad dressing, cottage cheese dressing, dips, bakery products and bakery fillings, surface glazes and icing, spreads, pizza toppings, confectionery and confectionery fillings, olives, olive brine, olive oil, juices, tomato purees and paste, condiments, and fruit pulp and the like food products.

The term “feed products” as used herein is also to be understood in a very broad sense and includes, but is not limited to, pet food, broiler feed, etc.

The term “pharmaceutical product” as used herein is also to be understood in a very broad sense and includes products comprising an active molecule such as a drug, agent, or pharmaceutical compound and optionally a pharmaceutically acceptable excipient, i.e. any inert substance that is combined with the active molecule for preparing an agreeable or convenient dosage form.

The term “cosmetic product” as used herein is also to be understood in a very broad sense and includes products that are used for protecting or treating horny tissues such as skin and lips, hair and nails from drying by preventing transpiration of moisture thereof and further conditioning the tissues as well as giving good appearance to these tissues. Products contemplated by the term “cosmetic product” include, but are not limited to, moisturizers, personal cleansing products, occlusive drug delivery patches, nail polish, powders, wipes, hair conditioners, skin treatment emulsions, shaving creams and the like.

The term “agricultural products” as used herein is also to be understood in a very broad sense and includes, but is not limited to, cereals, e.g. wheat, barley, rye, oats, rice, sorghum and the like; beets, e.g. sugar beet and fodder beet; pome and stone fruit and berries, e.g. apples, pears, plums, apricots, peaches, almonds, cherries, strawberries, raspberries and blackberries; leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes, aubergines; fibrous plants, e.g. cotton, flax, hemp, jute; citrus fruit, e.g. oranges, lemons, grapefruits, mandarins, limes; tropical fruit, e.g. papayas, passion fruit, mangos, carambolas, pineapples, bananas, kiwis; vegetables, e.g. spinach, lettuce, asparagus, brassicaceae such as cabbages and turnips, carrots, onions, tomatoes, potatoes, seed-potatoes, hot and sweet peppers; laurel-like plants, e.g. avocado, cinnamon, camphor tree; or products such as maize, tobacco, nuts, coffee, sugarcane, tea, grapevines, hops, rubber plants, as well as ornamental plants, e.g. cut flowers, roses, tulips, lilies, narcissus, crocuses, hyacinths, dahlias, gerbera, carnations, fuchsias, chrysanthemums, and flower bulbs, shrubs, deciduous trees and evergreen trees such as conifers, plants and trees in greenhouses. It includes, but is not limited to, plants and their parts, fruits, seeds, cuttings, cultivars, grafts, bulbs, tubers, root-tubers, rootstocks, cut flowers and vegetables.

A method for preparing a composition as described herein is another aspect of the present invention. The method comprises adding a polyene antifungal compound to at least one antifungal compound from the family of dicarboximide fungicides. The compounds may for instance be added separately to an aqueous composition and mixed, followed, if necessary, by adjustment of the pH, viscosity, etc. If added separately, some or all of the separate compounds may be in powder form, but alternatively some or all may also be in liquid form. The compounds may for instance also be added to one another in powder form and mixed to obtain a powdered composition. The powdered composition may then be added to an aqueous composition.

### EXAMPLES

### Example 1

### Pre-Harvest Application

Leaves of banana plants are inoculated with fungi. As a control non-inoculated leaves are also included. Next, a defined part of the leaves are treated with composition 1 (natamycin), composition 2 (iprodione), composition 3 (procymidone), composition 4 (vinclozolin), composition 5 (natamycin+iprodione), composition 6 (natamycin+procymidone) or composition 7 (natamycin+vinclozolin). Each composition is applied by spraying. Untreated leaves are also included (untreated control).

The obtained results show that the compositions of the present invention protect banana plants from fungal growth and further demonstrate that the compositions of the present invention show a synergistically enhanced activity compared to the activity of the active compounds when applied individually.

### Example 2

### Post-Harvest Application

Bananas are injured according to the method described by de Lapeyre de Bellaire and Dubois (1987). Bananas are wounded using a cork borer followed by contamination with fungal spores. After incubation for several hours at room temperature, the bananas are dipped in one of the following compositions: a) no treatment (control 1), b) dipped in water (control 2), c) dipped in natamycin, d) dipped in iprodione, e) dipped in procymidone, f) dipped in vinclozolin, g) dipped in natamycin+iprodione, h) dipped in natamycin+procymidone and i) dipped in natamycin+vinclozolin. After this treatment the bananas are incubated in closed boxes at 21° C. at elevated humidity. Each day the bananas are judged visually on fungal development.

The results show that the composition comprising natamycin and at least one antifungal compound from the family of dicarboximide fungicides protects bananas better against fungi than natamycin or at least one antifungal compound from the family of dicarboximide fungicides alone. Surprisingly, the combined application of natamycin and at least one antifungal compound from the family of dicarboximide fungicides leads to a strong synergistic reduction in infection.

### Example 3

### Treatment of Strawberries

Ten fresh, organic strawberries were used per treatment. Each strawberry was wounded with a 0.5 mm long cut and each wound was inoculated with 10 μl of a Botrytis cinerea suspension containing 1×10⁵ of spores/ml. After a 2-hour incubation period at 20° C., each strawberry was dipped individually for 1 minute in a freshly prepared aqueous antifungal composition comprising either 500 ppm natamycin (DSM Food Specialties, Delft, The Netherlands), 2000 ppm procymidone or both. The antifungal composition also comprised 3.1% (w/w) beeswax, 0.76% (w/w) glycerol, 0.66% (w/w) polyoxyethylene sorbitan monostearate (Tween 60), 0.03% (w/w) methylhydroxyethyl-cellulose (MHEC), 0.02% (w/w) xanthan gum, 0.02% (w/w) anti-foaming agent, 0.15% (w/w) citric acid and 0.01% (w/w) potassium sorbate. The pH of the compositions was 4. A composition without natamycin or procymidone was used as control. The treated strawberries were incubated in a closed box in the dark at 20° C. for 13 days.

During incubation, mould growth on the strawberries was assessed in a twofold manner: (i) the number of moulded strawberries per total of 10 strawberries was counted; and (ii) the antifungal activity (in %) of the individual and combined active ingredients was determined by calculating the reduction in mould growth observed on the strawberries treated with the antifungal composition in comparison to the mould growth on the strawberries treated with the control composition. The expected antifungal activity (E in %) of the combined antifungal composition comprising both active ingredients was calculated according to the Colby equation (Colby, 1967):

E=X+Y−[(X·Y)/100]

wherein X and Y are the observed antifungal activities (in %) of the individual active ingredients X and Y, respectively. If the observed antifungal activity (O in %) of the combination exceeds the expected antifungal activity (E in %) of the combination and the synergy factor O/E is thus >1.0, the combined application of the active ingredients leads to a synergistic antifungal effect.

The results in Table 1 (number of moulded strawberries per total of 10 strawberries) and Table 2 (antifungal activity) clearly demonstrate that the antifungal composition comprising 500 ppm natamycin and 2000 ppm procymidone had a much stronger antifungal effect on strawberries than natamycin or procymidone alone.

After 5 days of incubation, all 10 strawberries treated with the control composition showed mould growth, whereas 9 of the 10 strawberries treated with natamycin alone and 8 of the 10 strawberries treated with procymidone alone were moulded. However, mould growth was observed only for 4 of the 10 strawberries treated with the composition comprising natamycin and procymidone (see Table 1). Furthermore, the observed antifungal activity of the composition comprising both natamycin and procymidone exceeded the expected antifungal activity with 15%, which resulted in a synergy factor >1.0 (see Table 2).

After 6 days of incubation, all 10 strawberries treated with the control composition were moulded, as were 9 of the 10 strawberries treated with either natamycin alone or procymidone alone. However, only 5 of the 12 strawberries treated with the composition comprising natamycin and procymidone were moulded (see Table 1). In addition, the observed antifungal activity of the combined composition comprising natamycin and procymidone was >20% higher than the expected antifungal activity and a synergy factor >1.0 was obtained (see Table 2).

After 7, 8, 9, 10 and 12 days of incubation, all 10 strawberries treated with either the control composition, natamycin alone or procymidone alone showed mould growth. However, of the 10 strawberries treated with the active ingredient combination of natamycin and procymidone, only 5 strawberries were moulded after 7 days, 6 strawberries were moulded after 8, 9 and 10 days, and 7 strawberries were moulded after 12 days. Moreover, the observed antifungal activity was 27 to >40% higher than the expected antifungal activity between 7 and 13 days of incubation. Consequently, the corresponding synergy factor exceeded 1.0 during the entire 13-day incubation and increased from 1.2 on day 5 to as high as >33 on day 13 (see Table 2).

Hence, the combined application of 500 ppm natamycin and 2000 ppm procymidone has a surprisingly strong synergistic antifungal effect on strawberries.

### Example 4

### Treatment of Strawberries

The experiment was conducted as described in Example 3, except for the fact that each wounded and inoculated strawberry was dipped individually for 1 minute in a freshly prepared aqueous antifungal composition comprising either 500 ppm natamycin (DSM Food Specialties, Delft, The Netherlands), 1000 ppm procymidone or both. The treated strawberries were assessed on mould growth after 4, 5 and 7 days of incubation according to the two methods described in Example 3.

The results in Table 3 (antifungal activity) and Table 4 (number of moulded strawberries per total of 10 strawberries) reveal that the antifungal composition comprising 500 ppm natamycin as well as 1000 ppm procymidone was more successful in limiting mould growth on strawberries than the compositions comprising natamycin or procymidone individually.

After 4 days of incubation, the observed antifungal activity was 12% higher than the expected antifugal activity, which resulted in a synergy factor >1.0 (see Table 3).

After 5 and 7 days of incubation, all 10 strawberries treated with either the control composition or procymidone were moulded, as were 9 and 10 of the 10 strawberries treated with natamycin alone, respectively. However, when the active ingredient combination of natamycin and procymidone was applied on the strawberries, mould growth was observed for only 4 of the 10 strawberries on day 5 and 8 of the 10 strawberries on day 7 (see Table 4). Moreover, the observed antifungal activity of the composition comprising natamycin and procymidone exceeded the expected antifungal activity with 16 and 14% on day 5 and 7, respectively. Consequently, the obtained synergy factor was 1.3 on both days (see Table 3).

In conclusion, the results of this example prove that the combined application of 500 ppm natamycin and 1000 ppm procymidone synergistically reduces mould growth on strawberries.

### Example 5

### Treatment of Strawberries

The experiment was conducted as described in Example 3, except for the fact that each wounded and inoculated strawberry was dipped individually for 1 minute in a freshly prepared aqueous antifungal composition comprising either 250 ppm natamycin (DSM Food Specialties, Delft, The Netherlands), 500 ppm procymidone or both. The treated strawberries were incubated for 9 days and, as of day 5, assessed on mould growth daily. The antifungal activity (in %) of the individual and combined active ingredients was determined according to the method described in Example 3.

The results in Table 5 show that the antifungal composition comprising 250 ppm natamycin as well as 500 ppm procymidone was superior to the compositions comprising either natamycin alone or procymidone alone in reducing mould growth on strawberries.

After 5, 6, 7, 8, 9 days of incubation, the observed antifungal activity was 8 to 31% higher than the expected antifungal activity and the corresponding synergy factors ranged from 1.1 to 2.1 (see Table 5).

Thus, synergistic activity against fungi exists between 250 ppm natamycin and 500 ppm procymidone when applied in combination on strawberries.

### Example 6

### Treatment of Strawberries

The experiment was conducted as described in Example 3, except for the fact that each wounded and inoculated strawberry was dipped individually for 1 minute in a freshly prepared aqueous antifungal composition comprising either 250 ppm natamycin (DSM Food Specialties, Delft, The Netherlands), 250 ppm procymidone or both. During incubation, the treated strawberries were assessed on mould growth according to the two methods described in Example 3.

The results in Table 6 (number of moulded strawberries per total of 10 strawberries) and Table 7 (antifungal activity) unequivocally demonstrate that the combined antifungal composition comprising 250 ppm natamycin and 250 ppm procymidone protected strawberries more effectively against mould growth than the compositions comprising natamycin or procymdione individually.

After 4, 5, and 6 days of incubation, all 10 strawberries treated with either the control composition or procymidone alone were moulded, as were respectively 4, 7 and 9 of the strawberries treated with natamycin alone. However, of the 10 strawberries treated with the active ingredient combination of natamycin and procymidone, only 2, 3 and 6 strawberries were moulded after 4, 5 and 6 days of incubation, respectively (see Table 6). Furthermore, the observed antifungal activity exceeded the expected antifungal activity with 9% on day 4, 17% on day 5 and 24% on day 6 (see Table 7).

After 7, 8 and 9 days of incubation, all 10 strawberries treated with either the control composition, natamycin alone or procymidone alone showed mould growth. However, of the 10 strawberries treated with the composition comprising both natamycin and procymidone, only 7 strawberries were moulded on days 7 and 8 and 8 strawberries on day 9 (see Table 6). Moreover, the observed antifungal activity was 13 to 29% higher than the expected antifungal activity between 7 and 12 days of incubation. Consequently, the synergy factor exceeded 1.0 during the entire 12-day incubation period and even increased from 1.1 on day 4 to 3.6 on day 12 (see Table 7)

Thus, the combined application of 250 ppm natamycin and 250 ppm procymidone leads to a surprisingly strong synergistic reduction in mould growth on strawberries.

### Example 7

### Treatment of Mandarins

Ten fresh, organic mandarins were used per treatment. The peel of each mandarin was wounded once using a cork borer according to the method described by de Lapeyre de Bellaire and Dubois (1987). Subsequently, each wound was inoculated with 10 μl of a Penicillium italicum suspension containing 1×10⁴ of spores/ml. After incubation for 2 hours at 20° C., the mandarins were dipped individually for 1 minute in a freshly prepared aqueous antifungal composition comprising either 500 ppm natamycin (DSM Food Specialties, Delft, The Netherlands), 2000 ppm procymidone or both. In addition, the antifungal compositions comprised 3.1% (w/w) beeswax, 0.76% (w/w) glycerol, 0.66% (w/w) polyoxyethylene sorbitan monostearate (Tween 60), 0.03% (w/w) methylhydroxyethylcellulose (MHEC), 0.02% (w/w) xanthan gum, 0.02% (w/w) anti-foaming agent, 0.15% (w/w) citric acid and 0.01% (w/w) potassium sorbate. The pH of the compositions was 4. A composition without natamycin or procymidone was used as control.

The treated mandarins were incubated in a closed box in the dark at 20° C. and assessed on mould growth after 6, 8, 10, 13, 15 and 18 days of incubation. The antifungal activity (in %) of the individual and combined active ingredients was determined by calculating the reduction in mould growth observed on the mandarins treated with the antifungal composition in comparison to the mould growth on the mandarins treated with the control composition according to the Colby method (Colby, 1967) described in Example 3.

The results in Table 8 prove that the active ingredient combination of 500 ppm natamycin and 2000 ppm procymidone was more successful in limiting mould growth on mandarins than natamycin or procymidone individually.

After 6, 8, 10, 13, 15 and 18 days of incubation, the observed antifungal activity of composition comprising natamycin and procymidone exceeded the expected antifungal activity with 18 to 37%. The corresponding synergy factor was >1.0 on each of the aforementioned days and increased from 1.2 on day 6 to 1.8 on day 18 (see Table 8).

In conclusion, the results of this example clearly demonstrate the synergistic antifungal effect of 500 ppm natamycin and 2000 ppm procymidone when applied in combination on mandarins.

### Example 8

### Treatment of Apples

Twelf fresh, organic apples were used per treatment. Each apple was wounded once using a cork borer according to the method described by de Lapeyre de Bellaire and Dubois (1987). Subsequently, each wound was inoculated with 10 μl of a Botrytis cinerea suspension containing 1×10⁵ of spores/ml. After incubation for 2 hours at 20° C., the apples were dipped individually for 1 minute in a freshly prepared aqueous antifungal composition comprising either 250 ppm natamycin (DSM Food Specialties, Delft, The Netherlands), 500 ppm procymidone or both. In addition, the antifungal compositions comprised 3.1% (w/w) beeswax, 0.76% (w/w) glycerol, 0.66% (w/w) polyoxyethylene sorbitan monostearate (Tween 60), 0.03% (w/w) methylhydroxyethylcellulose (MHEC), 0.02% (w/w) xanthan gum, 0.02% (w/w) anti-foaming agent, 0.15% (w/w) citric acid and 0.01% (w/w) potassium sorbate. The pH of the compositions was 4. A composition without natamycin or procymidone was used as control. The treated apples were incubated in a closed box in the dark at 20° C.

During incubation, the mould growth on the apples was assessed in a twofold manner: (i) the number of moulded apples per total of 12 apples was counted; and (ii) the antifungal activity (in %) of the individual and combined active ingredients was determined by calculating the reduction in mould growth observed on the apples treated with the antifungal composition in comparison to the mould growth on the apples treated with the control composition according to the Colby method described in Example 3 (Colby, 1967).

The results in Table 9 (number of moulded apples per total of 12 apples) and Table 10 (antifungal activity) reveal that the antifungal activity of the composition comprising 250 ppm natamycin and 500 ppm procymidone was stronger than those of the compositions comprising natamycin or procymidone alone.

During 4 through 11 days of incubation, all apples treated with the control composition were moulded, as were 8 of the 10 apples treated with procymidone alone. When natamycin alone was used for treatment, mould growth was observed for 11 of the 12 apples on day 4 and all 12 apples on day 5 through 11. However, of the 12 apples treated with the composition comprising both procymidone and natamycin, 3 apples were moulded on day 4, 4 apples were moulded on days 5 and 6, and 6 of the 12 apples were moulded on day 7 through 11 (see Table 9).

After 12 and 13 days of incubation, all apples treated with either the control composition or natamycin alone showed mould growth, as did respectively 10 and 11 of the 12 apples treated with procymidone alone. However, when apples were treated with the composition comprising natamycin and procymidone, only 6 and 7 of 12 apples were moulded on day 12 and day 13, respectively (see Table 9). Furthermore, the observed antifungal activity of the active ingredient combination of natamycin and procymidone was almost 10% higher than the expected antifungal activity, which resulted in a synergy factor >1.0 (see Table 10).

During 14 through 25 days of incubation, all apples treated with either the control composition, natamycin alone or procymidone alone were moulded. However, the number of apples that showed mould growth after treatment with the composition comprising natamycin as well as procymidone remained at a constant 7 out of 12 in the incubation period from 14 to 25 days. The observed antifungal activity of the active ingredient combination of natamycin and procymidone exceeded the expected antifungal activity with 11 to almost 50%. Consequently, the synergy factor increased from 1.1 on day 13 to 2.3 on day 25 (see Table 10).

Thus, a remarkably strong antifungal activity exists between 250 ppm natamycin and 500 ppm procymidone when applied in combination on apples.

### Example 9

### Treatment of Apples

The experiment was conducted as described in Example 8, except for the fact that each wounded and inoculated apple was dipped individually for 1 minute in a freshly prepared aqueous antifungal composition comprising either 250 ppm natamycin (DSM Food Specialties, Delft, The Netherlands), 250 ppm procymidone or both. During incubation, the treated apples were assessed on mould growth according to the two methods described in Example 8.

The results in Table 11 (number of moulded apples per total of 12 apples) and Table 12 (antifungal activity) prove that the composition comprising 250 ppm natamycin and 250 ppm procymidone was more effective in reducing mould growth than natamycin or procymidone individually.

During 6 through 11 days of incubation, all apples treated with the control composition or natamycin alone were moulded. When procymidone alone was used for treatment, mould growth was observed for 7 of the 12 apples on day 6 and 8 of the 12 apples on day 7 through 11. However, of the 12 apples treated with the composition comprising both procymidone and natamycin, 4 apples were moulded on day 7 through 11 (see Table 11).

During 12 through 25 days of incubation, all apples treated with either the control composition, natamycin alone or procymidone alone showed mould growth. However, when apples were treated with the composition comprising natamycin and procymidone, mould growth was observed for only 5 of 12 treated apples on days 12 and 13 and 6 of 12 treated apples on day 14 through 25 (see Table 11). Moreover, the observed antifungal activity of the active ingredient combination of natamycin and procymidone exceeded the expected antifungal activity with 12 to >50%. Consequently, the synergy factor increased from 1.2 on day 13 to 2.9 on day 25 (see Table 12).

Thus, this example convincingly demonstrates the synergistic antifungal effect of the combined application of 250 ppm natamycin and 250 ppm procymidone on apples.

### Example 10

In Vitro Antifungal Activity

To demonstrate synergistic antifungal activity of the combination of natamycin with either iprodione, vinclozolin or procymidone against Botrytis cinerea, in vitro assays were conducted using 96-well microtiter plates. The following compositions were tested:

Control (no active ingredient),

1.25 ppm natamycin (DSM Food Specialties, Delft, The Netherlands),

3.0 or 8.0 ppm iprodione,

1.5 or 7.0 ppm vinclozolin,

1.25 or 2.0 ppm procymidone,

1.25 ppm natamycin+3.0 ppm iprodione,

1.25 ppm natamycin+8.0 ppm iprodione,

1.25 ppm natamycin+1.5 ppm vinclozolin,

1.25 ppm natamycin+7.0 ppm vinclozolin,

1.25 ppm natamycin+1.25 procymidone,

1.25 ppm natamycin+2.0 procymidone.

After filling each well of a microtiter plate with 84 μl of PCB medium, the active ingredient(s) were added from separate stock solutions prepared in PCB medium or methanol, which resulted in an intermediate volume of 100 μl per well. Subsequently, 100 μl of a Botrytis cinerea suspension prepared in PCB medium was used to inoculated each well with 2.5×10³ spores/ml. Each well thus contained a final volume of 200 μl and <1% of methanol, which did not affect growth of Botrytis cinerea (data not shown).

After incubation of the microtiter plates at 25° C., the in vitro antifungal activity (%) of the individual active ingredients was assessed by calculating the reduction in mould growth observed in the presence of the active ingredient in comparison to the mould growth observed in the absence of the active ingredient. The expected antifungal activity (E in %) of the active ingredient combination was calculated according to the Colby equation (Colby, 1967):

E=X+Y−[(X·Y)/100]

wherein X and Y are the observed antifungal activities (in %) of the individual active ingredients X and Y, respectively. If the observed antifungal activity (O in %) of the combination exceeds the expected antifungal activity (E in %) of the combination and the resulting synergy factor O/E is thus >1.0, the combined application of the active ingredients leads to a synergistic antifungal effect.

The results reveal that the active ingredient combinations of natamycin+iprodione (see Table 13), natamycin+vinclozolin (see Table 14) and natamycin+procymidone (see Table 14) were more effective in inhibiting growth of Botrytis cinerea than natamycin, iprodione, vinclozolin or procymidone individually. The observed antifungal activities of natamycin in combination with either iprodione, vinclozolin or procymidone were 25 to 100% higher than the expected antifungal activities. Consequently, the corresponding synergy factors all exceeded 1.0.

Hence, the active ingredient combinations of natamycin+iprodione, natamycin+vinclozolin and natamycin+procymidone synergistically inhibit growth of Botrytis cinerea.

### Example 11

### In Vitro Antifungal Activity

The experiment was conducted as described in Example 10, except for the fact that the following compositions were tested:

Control (no active ingredient),

0.63 ppm natamycin (DSM Food Specialties, Delft, The Netherlands),

5.0 ppm vinclozolin,

10 or 50 ppm procymidone,

0.63 ppm natamycin+5.0 ppm vinclozolin,

0.63 ppm natamycin+10 ppm procymidone,

0.63 ppm natamycin+50 ppm procymidone.

Furthermore, Penicillium italicum was used for inoculation. The antifungal activity (in %) of the individual and combined active ingredients was determined according to the method described in Example 10.

The results (see Table 15) reveal that the active ingredient combinations natamycin+vinclozolin and natamycin+procymidone inhibit growth of Penicillium italicum more effectively than natamycin, vinclozolin or procymidone individually. Moreover, the observed antifungal activities of the active ingredient combinations natamycin+vinclozolin and natamycin+procymidone exceeded the expected antifungal activities with 50% and synergy factors far above 1.0 were thus obtained.

In conclusion, the active ingredient combinations natamycin+vinclozolin and natamycin+procymidone have strong synergistic antifungal activity against Penicillium italicum.

TABLE 1
Number of moulded strawberries incubated at 20°
C. after treatment with compositions comprising either
500 ppm natamycin, 2000 ppm procymidone or both.

| | Number of moulded strawberries/ | | | | |
|---|---|---|---|---|---|
| | total number of 10 strawberries | | | | |
| | during incubation time (in days) | | | | |
| Antifungal | Day | Day | Day | Day | Day |
| composition | 5 | 6 | 7 | 8-10 | 12 |
| Control | 10/10 | 10/10 | 10/10 | 10/10 | 10/10 |
| Natamycin 500 ppm | 9/10 | 9/10 | 10/10 | 10/10 | 10/10 |
| Procymidone 2000 ppm | 8/10 | 9/10 | 10/10 | 10/10 | 10/10 |
| Natamycin 500 ppm + | 4/10 | 5/10 | 5/10 | 6/10 | 7/10 |
| procymidone 2000 ppm | | | | | |

TABLE 2
Antifungal activity (%) of compositions comprising
either 500 ppm natamycin, 2000 ppm procymidone or
both on strawberries after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 5 | 0 | — | — |
| Natamycin 500 ppm | | 12 | — | — |
| Procymidone 2000 ppm | | 63 | — | — |
| Natamycin 500 ppm + | | 83 | 68 | 1.2 |
| procymidone 2000 ppm | | | | |
| Control | 6 | 0 | — | — |
| Natamycin 500 ppm | | 4 | — | — |
| Procymidone 2000 ppm | | 51 | — | — |
| Natamycin 500 ppm + | | 74 | 53 | 1.4 |
| procymidone 2000 ppm | | | | |
| Control | 7 | 0 | — | — |
| Natamycin 500 ppm | | 7 | — | — |
| Procymidone 2000 ppm | | 38 | — | — |
| Natamycin 500 ppm + | | 75 | 43 | 1.7 |
| procymidone 2000 ppm | | | | |
| Control | 8 | 0 | — | — |
| Natamycin 500 ppm | | 5 | — | — |
| Procymidone 2000 ppm | | 35 | — | — |
| Natamycin 500 ppm + | | 65 | 38 | 1.7 |
| procymidone 2000 ppm | | | | |
| Control | 9 | 0 | — | — |
| Natamycin 500 ppm | | 3 | — | — |
| Procymidone 2000 ppm | | 23 | — | — |
| Natamycin 500 ppm + | | 60 | 26 | 2.3 |
| procymidone 2000 ppm | | | | |
| Control | 10 | 0 | — | — |
| Natamycin 500 ppm | | 3 | — | — |
| Procymidone 2000 ppm | | 13 | — | — |
| Natamycin 500 ppm + | | 57 | 16 | 3.6 |
| procymidone 2000 ppm | | | | |
| Control | 12 | 0 | — | — |
| Natamycin 500 ppm | | 0 | — | — |
| Procymidone 2000 ppm | | 2 | — | — |
| Natamycin 500 ppm + | | 45 | 2 | 23 |
| procymidone 2000 ppm | | | | |
| Control | 13 | 0 | — | — |
| Natamycin 500 ppm | | 0 | — | — |
| Procymidone 2000 ppm | | 0 | — | — |
| Natamycin 500 ppm + | | 33 | 0 | >33 |
| procymidone 2000 ppm | | | | |

TABLE 3
Antifungal activity (%) of compositions comprising
either 500 ppm natamycin, 1000 ppm procymidone or
both on strawberries after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 4 | 0 | — | — |
| Natamycin 500 ppm | | 36 | — | — |
| Procymidone 1000 ppm | | 69 | — | — |
| Natamycin 500 ppm + | | 92 | 80 | 1.2 |
| procymidone 1000 ppm | | | | |
| Control | 5 | 0 | — | — |
| Natamycin 500 ppm | | 12 | — | — |
| Procymidone 1000 ppm | | 59 | — | — |
| Natamycin 500 ppm + | | 80 | 64 | 1.3 |
| procymidone 1000 ppm | | | | |
| Control | 7 | 0 | — | — |
| Natamycin 500 ppm | | 7 | — | — |
| Procymidone 1000 ppm | | 44 | — | — |
| Natamycin 500 ppm + | | 62 | 48 | 1.3 |
| procymidone 1000 ppm | | | | |

TABLE 4
Number of moulded strawberries incubated at 20°
C. after treatment with compositions comprising either
500 ppm natamycin, 1000 ppm procymidone or both.

| | |
|---|---|
| | Number of moulded strawberries/ |
| | total number of 10 strawberries |
| Antifungal | during incubation time (in days) |

| composition | Day 5 | Day 7 |
|---|---|---|
| Control | 10/10 | 10/10 |
| Natamycin 500 ppm | 9/10 | 10/10 |
| Procymidone 1000 ppm | 10/10 | 10/10 |
| Natamycin 500 ppm + | 4/10 | 8/10 |
| procymidone 1000 ppm | | |

TABLE 5
Antifungal activity (%) of compositions comprising
either 250 ppm natamycin, 500 ppm procymidone or
both on strawberries after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 5 | 0 | — | — |
| Natamycin 250 ppm | | 34 | — | — |
| Procymidone 500 ppm | | 39 | — | — |
| Natamycin 250 ppm + | | 68 | 60 | 1.1 |
| procymidone 500 ppm | | | | |
| Control | 6 | 0 | — | — |
| Natamycin 250 ppm | | 15 | — | — |
| Procymidone 500 ppm | | 26 | — | — |
| Natamycin 250 ppm + | | 68 | 37 | 1.8 |
| procymidone 500 ppm | | | | |
| Control | 7 | 0 | — | — |
| Natamycin 250 ppm | | 11 | — | — |
| Procymidone 500 ppm | | 20 | — | — |
| Natamycin 250 ppm + | | 60 | 29 | 2.1 |
| procymidone 500 ppm | | | | |
| Control | 8 | 0 | — | — |
| Natamycin 250 ppm | | 10 | — | — |
| Procymidone 500 ppm | | 20 | — | — |
| Natamycin 250 ppm + | | 43 | 28 | 1.5 |
| procymidone 500 ppm | | | | |
| Control | 9 | 0 | — | — |
| Natamycin 250 ppm | | 5 | — | — |
| Procymidone 500 ppm | | 17 | — | — |
| Natamycin 250 ppm + | | 30 | 21 | 1.4 |
| procymidone 500 ppm | | | | |

TABLE 6
Number of moulded strawberries incubated at 20° C.
after treatment with compositions comprising either
250 ppm natamycin, 250 ppm procymidone or both.

| | Number of moulded strawberries/ | | | | | |
|---|---|---|---|---|---|---|
| | total number of 10 strawberries | | | | | |
| | during incubation time (in days) | | | | | |
| | | | Day | Day | Day | Day |
| Antifungal composition | Day 4 | Day 5 | 6 | 7 | 8 | 9 |
| Control | 10/10 | 10/10 | 10/10 | 10/10 | 10/10 | 10/10 |
| Natamycin 250 ppm | 4/10 | 7/10 | 9/10 | 10/10 | 10/10 | 10/10 |
| Procymidone 250 ppm | 10/10 | 10/10 | 10/10 | 10/10 | 10/10 | 10/10 |
| Natamycin 250 ppm + | 2/10 | 3/10 | 6/10 | 7/10 | 7/10 | 8/10 |
| procymidone 250 ppm | | | | | | |

TABLE 7
Antifungal activity (%) of compositions comprising
either 250 ppm natamycin, 250 ppm procymidone or
both on strawberries after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 4 | 0 | — | — |
| Natamycin 250 ppm | | 53 | — | — |
| Procymidone 250 ppm | | 58 | — | — |
| Natamycin 250 ppm + | | 89 | 80 | 1.1 |
| procymidone 250 ppm | | | | |
| Control | 5 | 0 | — | — |
| Natamycin 250 ppm | | 34 | — | — |
| Procymidone 250 ppm | | 41 | — | — |
| Natamycin 250 ppm + | | 78 | 61 | 1.3 |
| procymidone 250 ppm | | | | |
| Control | 6 | 0 | — | — |
| Natamycin 250 ppm | | 15 | — | — |
| Procymidone 250 ppm | | 34 | — | — |
| Natamycin 250 ppm + | | 68 | 44 | 1.5 |
| procymidone 250 ppm | | | | |
| Control | 7 | 0 | — | — |
| Natamycin 250 ppm | | 11 | — | — |
| Procymidone 250 ppm | | 31 | — | — |
| Natamycin 250 ppm + | | 58 | 38 | 1.5 |
| procymidone 250 ppm | | | | |
| Control | 8 | 0 | — | — |
| Natamycin 250 ppm | | 10 | — | — |
| Procymidone 250 ppm | | 27 | — | — |
| Natamycin 250 ppm + | | 53 | 34 | 1.6 |
| procymidone 250 ppm | | | | |
| Control | 9 | 0 | — | — |
| Natamycin 250 ppm | | 5 | — | — |
| Procymidone 250 ppm | | 13 | — | — |
| Natamycin 250 ppm + | | 47 | 18 | 2.6 |
| procymidone 250 ppm | | | | |
| Control | 10 | 0 | — | — |
| Natamycin 250 ppm | | 3 | — | — |
| Procymidone 250 ppm | | 10 | — | — |
| Natamycin 250 ppm + | | 37 | 13 | 2.8 |
| procymidone 250 ppm | | | | |
| Control | 12 | 0 | — | — |
| Natamycin 250 ppm | | 0 | — | — |
| Procymidone 250 ppm | | 5 | — | — |
| Natamycin 250 ppm + | | 18 | 5 | 3.6 |
| procymidone 250 ppm | | | | |

TABLE 8
Antifungal activity (%) of compositions comprising
either 500 ppm natamycin, 2000 ppm procymidone or
both on mandarins after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 6 | 0 | — | — |
| Natamycin 500 ppm | | 82 | — | — |
| Procymidone 2000 ppm | | 0 | — | — |
| Natamycin 500 ppm + | | 100 | 82 | 1.2 |
| procymidone 2000 ppm | | | | |
| Control | 8 | 0 | — | — |
| Natamycin 500 ppm | | 73 | — | — |
| Procymidone 2000 ppm | | 0 | — | — |
| Natamycin 500 ppm + | | 100 | 73 | 1.4 |
| procymidone 2000 ppm | | | | |
| Control | 10 | 0 | — | — |
| Natamycin 500 ppm | | 66 | — | — |
| Procymidone 2000 ppm | | 0 | — | — |
| Natamycin 500 ppm + | | 97 | 66 | 1.5 |
| procymidone 2000 ppm | | | | |
| Control | 13 | 0 | — | — |
| Natamycin 500 ppm | | 59 | — | — |
| Procymidone 2000 ppm | | 0 | — | — |
| Natamycin 500 ppm + | | 90 | 59 | 1.5 |
| procymidone 2000 ppm | | | | |
| Control | 15 | 0 | — | — |
| Natamycin 500 ppm | | 55 | — | — |
| Procymidone 2000 ppm | | 0 | — | — |
| Natamycin 500 ppm + | | 86 | 55 | 1.6 |
| procymidone 2000 ppm | | | | |
| Control | 18 | 0 | — | — |
| Natamycin 500 ppm | | 44 | — | — |
| Procymidone 2000 ppm | | 0 | — | — |
| Natamycin 500 ppm + | | 81 | 44 | 1.8 |
| procymidone 2000 ppm | | | | |

TABLE 9
Number of moulded apples incubated at 20° C. after
treatment with compositions comprising either 250 ppm
natamycin, 500 ppm procymidone or both.

| | Number of moulded apples/ | | | | | |
|---|---|---|---|---|---|---|
| | total number of 12 apples | | | | | |
| | during incubation time (in days) | | | | | |
| | | Day | Day | Day | Day | Day |
| Antifungal composition | Day 4 | 5-6 | 7-11 | 12 | 13 | 14-25 |
| Control | 12/12 | 12/12 | 12/12 | 12/12 | 12/12 | 12/12 |
| Natamycin 250 ppm | 11/12 | 12/12 | 12/12 | 12/12 | 12/12 | 12/12 |
| Procymidone 500 ppm | 8/12 | 8/12 | 8/12 | 10/12 | 11/12 | 12/12 |
| Natamycin 250 ppm + | 3/12 | 4/12 | 6/12 | 6/12 | 7/12 | 7/12 |
| procymidone 500 ppm | | | | | | |

TABLE 10
Antifungal activity (%) of compositions comprising
either 250 ppm natamycin, 500 ppm procymidone or
both on apples after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 13 | 0 | — | — |
| Natamycin 250 ppm | | 31 | — | — |
| Procymidone 500 ppm | | 75 | — | — |
| Natamycin 250 ppm + | | 92 | 83 | 1.1 |
| procymidone 500 ppm | | | | |
| Control | 14 | 0 | — | — |
| Natamycin 250 ppm | | 26 | — | — |
| Procymidone 500 ppm | | 71 | — | — |
| Natamycin 250 ppm + | | 90 | 79 | 1.1 |
| procymidone 500 ppm | | | | |
| Control | 15 | 0 | — | — |
| Natamycin 250 ppm | | 23 | — | — |
| Procymidone 500 ppm | | 67 | — | — |
| Natamycin 250 ppm + | | 90 | 74 | 1.2 |
| procymidone 500 ppm | | | | |
| Control | 17 | 0 | — | — |
| Natamycin 250 ppm | | 18 | — | — |
| Procymidone 500 ppm | | 57 | — | — |
| Natamycin 250 ppm + | | 90 | 65 | 1.4 |
| procymidone 500 ppm | | | | |
| Control | 18 | 0 | — | — |
| Natamycin 250 ppm | | 18 | — | — |
| Procymidone 500 ppm | | 51 | — | — |
| Natamycin 250 ppm + | | 89 | 60 | 1.5 |
| procymidone 500 ppm | | | | |
| Control | 20 | 0 | — | — |
| Natamycin 250 ppm | | 16 | — | — |
| Procymidone 500 ppm | | 45 | — | — |
| Natamycin 250 ppm + | | 89 | 54 | 1.6 |
| procymidone 500 ppm | | | | |
| Control | 22 | 0 | — | — |
| Natamycin 250 ppm | | 14 | — | — |
| Procymidone 500 ppm | | 38 | — | — |
| Natamycin 250 ppm + | | 88 | 47 | 1.9 |
| procymidone 500 ppm | | | | |
| Control | 25 | 0 | — | — |
| Natamycin 250 ppm | | 14 | — | — |
| Procymidone 500 ppm | | 26 | — | — |
| Natamycin 250 ppm + | | 86 | 37 | 2.3 |
| procymidone 500 ppm | | | | |

TABLE 11
Number of moulded apples incubated at 20° C.
after treatment with compositions comprising either
250 ppm natamycin, 250 ppm procymidone or both.

Number of moulded apples/
total number of 12 apples
during incubation time (in days)

| Antifungal | Day | Day | Day | Day |
|---|---|---|---|---|
| composition | 6 | 7-11 | 12-13 | 14-25 |
| Control | 12/12 | 12/12 | 12/12 | 12/12 |
| Natamycin 250 ppm | 12/12 | 12/12 | 12/12 | 12/12 |
| Procymidone 250 ppm | 7/12 | 8/12 | 12/12 | 12/12 |
| Natamycin 250 ppm + | 4/12 | 4/12 | 5/12 | 6/12 |
| procymidone 250 ppm | | | | |

TABLE 12
Antifungal activity (%) of compositions comprising
either 250 ppm natamycin, 250 ppm procymidone or
both on apples after incubation at 20° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 13 | 0 | — | — |
| Natamycin 250 ppm | | 31 | — | — |
| Procymidone 250 ppm | | 65 | — | — |
| Natamycin 250 ppm + | | 88 | 76 | 1.2 |
| procymidone 250 ppm | | | | |
| Control | 14 | 0 | — | — |
| Natamycin 250 ppm | | 26 | — | — |
| Procymidone 250 ppm | | 55 | — | — |
| Natamycin 250 ppm + | | 86 | 67 | 1.3 |
| procymidone 250 ppm | | | | |
| Control | 15 | 0 | — | — |
| Natamycin 250 ppm | | 23 | — | — |
| Procymidone 250 ppm | | 50 | — | — |
| Natamycin 250 ppm + | | 85 | 62 | 1.4 |
| procymidone 250 ppm | | | | |
| Control | 17 | 0 | — | — |
| Natamycin 250 ppm | | 18 | — | — |
| Procymidone 250 ppm | | 44 | — | — |
| Natamycin 250 ppm + | | 84 | 54 | 1.6 |
| procymidone 250 ppm | | | | |
| Control | 18 | 0 | — | — |
| Natamycin 250 ppm | | 18 | — | — |
| Procymidone 250 ppm | | 37 | — | — |
| Natamycin 250 ppm + | | 84 | 48 | 1.8 |
| procymidone 250 ppm | | | | |
| Control | 20 | 0 | — | — |
| Natamycin 250 ppm | | 16 | — | — |
| Procymidone 250 ppm | | 31 | — | — |
| Natamycin 250 ppm + | | 84 | 42 | 2.0 |
| procymidone 250 ppm | | | | |
| Control | 22 | 0 | — | — |
| Natamycin 250 ppm | | 14 | — | — |
| Procymidone 250 ppm | | 26 | — | — |
| Natamycin 250 ppm + | | 83 | 37 | 2.2 |
| procymidone 250 ppm | | | | |
| Control | 25 | 0 | — | — |
| Natamycin 250 ppm | | 14 | — | — |
| Procymidone 250 ppm | | 17 | — | — |
| Natamycin 250 ppm + | | 83 | 29 | 2.9 |
| procymidone 250 ppm | | | | |

TABLE 13
In vitro antifungal activity (%) of natamycin in combination with
iprodione against Botrytis cinerea after incubation at 25° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 5 | 0 | — | — |
| Natamycin 1.25 ppm | | 50 | — | — |
| Iprodione 3.0 ppm | | 50 | — | — |
| Natamycin 1.25 ppm + | | 100 | 75 | 1.3 |
| Iprodione 3.0 ppm | | | | |
| Control | 12 | 0 | — | — |
| Natamycin 1.25 ppm | | 0 | — | — |
| Iprodione 8.0 ppm | | 50 | — | — |
| Natamycin 1.25 ppm + | | 100 | 50 | 2.0 |
| Iprodione 8.0 ppm | | | | |

TABLE 14
In vitro antifungal activity (%) of natamycin in combination
with either vinclozolin or procymidone against Botrytis cinerea
after incubation at 25° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 3 | 0 | — | — |
| Natamycin 1.25 ppm | | 0 | — | — |
| Vinclozolin 1.5 ppm | | 0 | — | — |
| Procymidone 1.25 ppm | | 0 | — | — |
| Natamycin 1.25 ppm + | | 100 | 0 | >100 |
| Vinclozolin 1.5 ppm | | | | |
| Natamycin 1.25 ppm + | | 100 | 0 | >100 |
| Procymidone 1.25 ppm | | | | |
| Control | 6 | 0 | — | — |
| Natamycin 1.25 ppm | | 0 | — | — |
| Vinclozolin 1.5 ppm | | 0 | — | — |
| Procymidone 1.25 ppm | | 0 | — | — |
| Natamycin 1.25 ppm + | | 50 | 0 | >50 |
| Vinclozolin 1.5 ppm | | | | |
| Natamycin 1.25 ppm + | | 50 | 0 | >50 |
| Procymidone 1.25 ppm | | | | |
| Control | 10 | 0 | — | — |
| Natamycin 1.25 ppm | | 0 | — | — |
| Vinclozolin 7.0 ppm | | 0 | — | — |
| Procymidone 2.0 ppm | | | — | — |
| Natamycin 1.25 ppm + | | 50 | 0 | >50 |
| Vinclozolin 7.0 ppm | | | | |
| Natamycin 1.25 ppm + | | 50 | 0 | >50 |
| Procymidone 2.0 ppm | | | | |

TABLE 15
In vitro antifungal activity (%) of natamycin in combination
with either vinclozolin or procymidone against Penicillium italicum
after incubation at 25° C.

| | | Observed | Expected | |
|---|---|---|---|---|
| | Incubation | antifungal | antifungal | Synergy |
| Antifungal | time | activity | activity | factor |
| composition | (days) | O (%) | E (%) | O/E |
| Control | 3 | 0 | — | — |
| Natamycin 0.63 ppm | | 0 | — | — |
| Vinclozolin 5.0 ppm | | 0 | — | — |
| Procymidone 10 ppm | | 0 | — | — |
| Natamycin 0.63 ppm + | | 50 | 0 | >50 |
| Vinclozolin 5.0 ppm | | | | |
| Natamycin 0.63 ppm + | | 50 | 0 | >50 |
| Procymidone 10 ppm | | | | |
| Control | 5 | 0 | — | — |
| Natamycin 0.63 ppm | | 0 | — | — |
| Procymidone 50 ppm | | 0 | — | — |
| Natamycin 0.63 ppm + | | 50 | 0 | >50 |
| Procymidone 50 ppm | | | | |

### REFERENCES

Colby S R (1967), Calculating synergistic and antagonistic responses of herbicide combination. Weeds 15:20-22.
Lapeyre de Bellaire de L and Dubois C (1987), Distribution of Thiabendazole-Resistant Colletotrichum musae Isolates from Guadeloupe Banana Plantations. Plant Disease 81:1378-1383.
Locke T and Fletcher J T (1988), Incidence of benomyl and iprodione resistance in isolates of Botrytis cinerea in tomato crops in England and Wales in 1986. Plant Pathol. 37:381-384.
Pommer E H and Lorenz G (1982), Resistance of Botrytis cinerea Pers. To dicarboximide fungicides—a literature review. Crop Protection 1:221-230.
Slinker B K (1998), The Statistics of Synergism. Journal of Mol. and Cell. Cardiology 30:723-731.
Yourman L F and Jeffers S N (1999), Resistance to Benzimidazole and Dicarboximide Fungicides in Greenhouse Isolates of Botrytis cinerea. Plant Disease 83: 569-575.

1.-15. (canceled)

16. A composition comprising natamycin and at least one antifungal compound from the family of dicarboximide fungicides selected from the group consisting of famoxadone, fluoroimide, chlozolinate, dichlozoline, iprodione, isovaledione, myclozolin, procymidone and vinclozolin.

17. A composition according to claim 16, wherein the composition further comprises at least one additional compound selected from the group consisting of a sticking agent, a carrier, a colouring agent, a protective colloid, an adhesive, a herbicide, a fertilizer, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber and an antioxidant.

18. A composition according to claim 16, wherein the amount of natamycin is in a range from 0.005 g/l to about 100 g/l and the amount of the at least one antifungal compound from the family of dicarboximide fungicides is in a range from about 0.0001 g/l to about 2000 g/l.

19. A kit comprising natamycin and at least one antifungal compound from the family of dicarboximide fungicides selected from the group consisting of famoxadone, fluoroimide, chlozolinate, dichlozoline, iprodione, isovaledione, myclozolin, procymidone and vinclozolin.

20. A method for protecting a product against fungi by treating the product with natamycin and at least one antifungal compound from the family of dicarboximide fungicides selected from the group consisting of famoxadone, fluoroimide, chlozolinate, dichlozoline, iprodione, isovaledione, myclozolin, procymidone and vinclozolin.

21. A method according to claim 20, wherein the product is treated with a composition comprising natamycin and said at least one antifungal compound.

22. A method according to claim 20, wherein the product is at least one selected from the group consisting of a food product, a feed product, a pharmaceutical product, a cosmetic product and an agricultural product.

23. A method according to claim 22, wherein the product is an agricultural product.

24. A method according to claim 23, wherein the product is treated post-harvest.

25. A product comprising natamycin and at least one antifungal compound from the family of dicarboximide fungicides selected from the group consisting of famoxadone, fluoroimide, chlozolinate, dichlozoline, iprodione, isovaledione, myclozolin, procymidone and vinclozolin.

26. A product according to claim 25, wherein the product is at least one selected from the group consisting of a food product, a feed product, a pharmaceutical product, a cosmetic product and an agricultural product.

27. A product according to claim 26, wherein the product is an agricultural product.
